(19) United States
(12) Patent Application Publication
(10) Pub. No.: US 2024/0207988 A1
(43) Pub. Date: Jun. 27, 2024

(54) WORKPIECE HOLDING DEVICE AND WORKPIECE HOLDING METHOD

(71) Applicant: NHK SPRING CO., LTD., Yokohama-shi (JP)

(72) Inventor: Kenichiro NAKANO, Yokohama-shi (JP)

(73) Assignee: NHK SPRING CO., LTD., Yokohama-shi (JP)

(21) Appl. No.: 18/543,150

(22) Filed: Dec. 18, 2023

(30) Foreign Application Priority Data
Dec. 21, 2022 (JP) 2022-204704

(51) Int. Cl. B23Q 3/06

(52) U.S. Cl. CPC B23Q 3/062

(57) ABSTRACT

A workpiece holding device includes a suction chuck unit which includes an adsorption member, a chuck mechanism and a drive mechanism. When a drive member of the drive mechanism moves to a lower side, the chuck mechanism moves to an open position, and an adsorption portion is located at the position of a first height. After the adsorption portion adsorbs a cap member the drive member moves to a second height which is higher than the first height. When the drive member has moved to the second height, the cap member rises relative to a pin member. In this state, the chuck mechanism is closed. When the chuck mechanism is closed, of the pin member, a portion which is not covered with the cap member is sandwiched by the chuck mechanism.

### CROSS-REFERENCE TO RELATED APPLICATIONS

This application is based upon and claims the benefit of priority from prior Japanese Patent Application No. 2022-204704, filed Dec. 21, 2022, the entire contents of which are incorporated herein by reference.

### BACKGROUND OF THE INVENTION

### 1. Field of the Invention

The present invention relates to a workpiece holding device for holding, for example, a complex workpiece which consists of a pin member and a cap member, and a workpiece holding method.

### 2. Description of the Related Art

Complex workpieces each of which consists of a pin member and a cap member are known. An example of the pin member is a small component having the shape of a rod comprising a circular section. Another example of the pin member is a small coil spring having the shape of a long and thin cylinder. The pin member is covered with the cap member. For example, the pin member is covered with the cap member from the upper side of the pin member in a state where the pin member stands upright. In this structure, the pin member is covered with the cap member over a certain degree of length.

Automated assembly facilities which handle complex workpieces each comprising a pin member and a cap member are known. The automated assembly facilities are required to hold and move the complex workpieces by a robot, etc. For example, JP H06-71717 B (Patent Literature 1) describes an example of a chuck which sandwiches a hollow workpiece in a radial direction. The chuck of Patent Literature 1 can grip a workpiece in a radial direction. However, in a case of a complex workpiece consisting of a pin member and a cap member, it is difficult to grip the pin member and the cap member at the same time by using the mere chuck.

In a complex workpiece which consists of a pin member and a cap member, the rigidity of the cap member in a radial direction is less in some cases. In such a workpiece, when the cap member is sandwiched in a radial direction by a chuck, the cap member may be deformed. Thus, there is a desire to sandwich the pin member. In view of this situation, the inventor of the present application and his fellow workers considered a chuck mechanism which can sandwich the pin member in a radial direction to hold the complex workpiece.

However, in some cases, it is difficult to sandwich a pin member in a radial direction by a chuck in a state where the pin member is covered with a cap member. For example, a grip portion for the chuck cannot be assured in the pin member in a state where the pin member is covered with the cap member depending on the form of the complex workpiece.

The object of the present invention is to provide a workpiece holding device which can hold a complex workpiece comprising a pin member and a cap member, and a workpiece holding method.

### BRIEF SUMMARY OF THE INVENTION

In general, according to an embodiment, a workpiece holding device holds a complex workpiece comprising a pin member and a cap member. The workpiece holding device comprises an adsorption member, a chuck mechanism and a drive mechanism. The adsorption member is provided above a jig which supports the complex workpiece, and comprises an adsorption portion which adsorbs the cap member. The chuck mechanism comprises a first chuck member and a second chuck member moving so as to open and close each other. Of the pin member, a portion which is not covered with the cap member is sandwiched between the first chuck member and the second chuck member in a state where the cap member is adsorbed to the adsorption portion. The drive mechanism opens and closes the chuck mechanism and moves the adsorption member in a vertical direction.

According to the workpiece holding device of the embodiment, the pin member and the cap member can be held at the same time. As the chuck mechanism of the workpiece holding device sandwiches the pin member in a radial direction, it is possible to avoid the application of a force which deforms the cap member to the cap member.

In the workpiece holding device of the embodiment, the drive mechanism may comprise a drive member and a drive source. The drive member is movable in a vertical direction relative to the adsorption member. The drive source moves the drive member in the vertical direction. The drive member may comprise a vertical drive portion and a chuck drive portion. The vertical drive portion may include a pressure portion.

The pressure portion moves the adsorption portion to a first height facing the cap member, and moves the adsorption portion to a second height which is higher than the first height. The chuck drive portion may include a cam portion. The cam portion moves the chuck mechanism to an open position when the adsorption portion moves to the first height. The cam portion moves the chuck mechanism from the open position to a closed position when the adsorption portion has moved from the first height to the second height.

In the workpiece holding device of the embodiment, the drive member may comprise the cam portion and the pressure portion. The workpiece holding device of the embodiment may comprise a pair of positioning pins extending downward on both sides of the adsorption portion of a lower surface of the adsorption member.

The workpiece holding device of the embodiment may comprise a first axis which rotatably supports the first chuck member, a second axis which rotatably supports the second chuck member, and a spring. The spring urges the first chuck member and the second chuck member such that they close each other. A first gap portion may be defined between a side surface of the adsorption member and the first chuck member. A second gap portion may be defined between the other side surface of the adsorption member and the second chuck member. When these gap portions are defined, the first chuck member and the second chuck member are rotatable to some extent around the first axis and the second axis, respectively, in a state where the chuck mechanism is closed.

A shim member may be provided between the adsorption member and the first chuck member and/or between the adsorption member and the second chuck member.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of part of a workpiece holding device according to a first embodiment.

FIG. 2 is a front view of part of the workpiece holding device shown in FIG. 1.

FIG. 3 is a side view of a state in which the chuck mechanism of the workpiece holding device shown in FIG. 1 is closed.

FIG. 4 is a side view of a state in which the chuck mechanism of the workpiece holding device shown in FIG. 1 is open.

FIG. 5 is a flowchart showing a process for holding a complex workpiece.

FIG. 6 is a cross-sectional view showing an example of the complex workpiece.

FIG. 7 is a cross-sectional view in which the complex workpiece shown in FIG. 6 is disassembled.

FIG. 8A is a cross-sectional view showing an example of a jig.

FIG. 8B is a cross-sectional view showing the jig in a state where a pin member is inserted into the jig.

FIG. 9A is a cross-sectional view of the jig showing a state in which the pin member is covered with a cap member.

FIG. 9B is a cross-sectional view showing a state in which an upper jig is removed.

FIG. 10 is a cross-sectional view showing a state in which the adsorption portion of the workpiece holding device has moved to a first height.

FIG. 11 is a cross-sectional view showing a state in which the adsorption portion of the workpiece holding device has moved to a second height.

FIG. 12 is a cross-sectional view showing a state in which the chuck mechanism of the workpiece holding device is closed.

FIG. 13 is a cross-sectional view showing a state in which the suction chuck unit of the workpiece holding device has moved to the upper side.

FIG. 14 is a bottom plan view in which part of the chuck mechanism of a workpiece holding device and a pin member are viewed from the lower side according to a second embodiment.

FIG. 15 is a cross-sectional view showing part of the workpiece holding device shown in FIG. 14.

FIG. 16 is a side view showing part of a workpiece holding device according to a third embodiment.

### DETAILED DESCRIPTION OF THE INVENTION

### [First Embodiment]

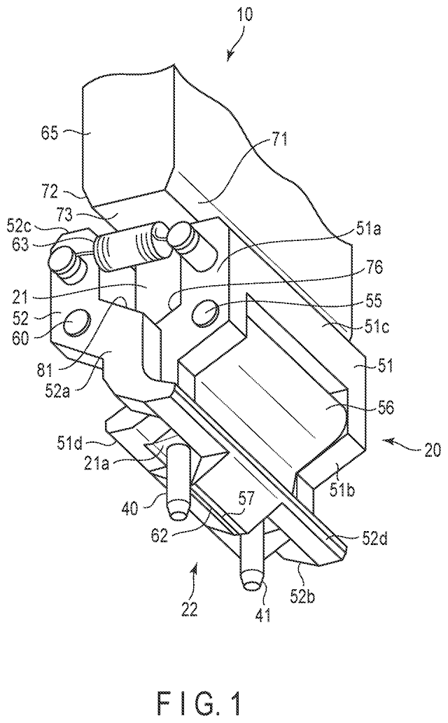

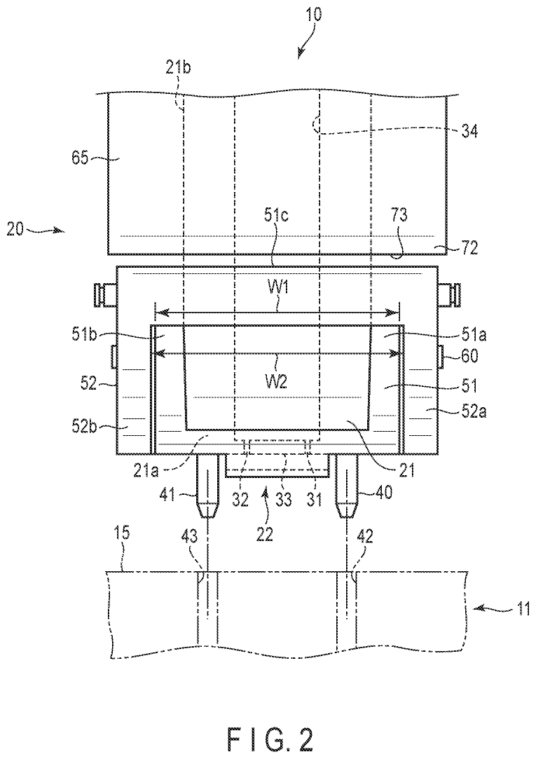

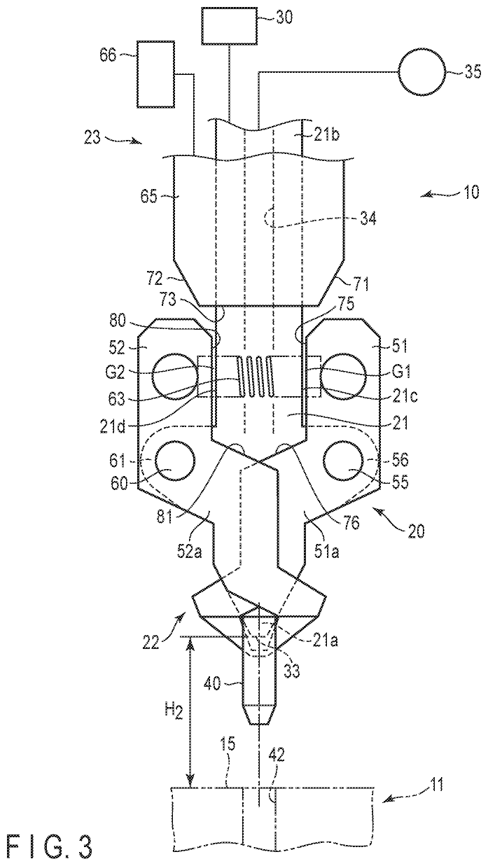

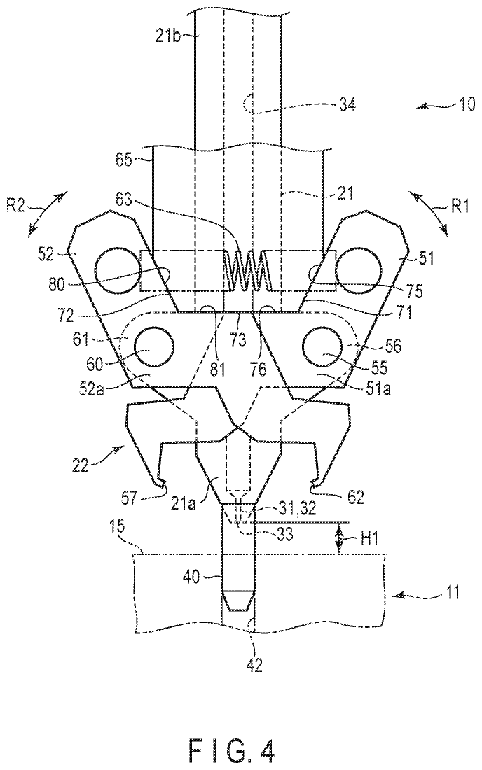

This specification explains a workpiece holding device 10 according to a first embodiment below, referring to FIG. 1 to FIG. 13. FIG. 1 is a perspective view in which part of the workpiece holding device 10 is viewed from an obliquely lower side. FIG. 2 is a front view of part of the workpiece holding device 10. FIG. 3 is a side view showing part of the workpiece holding device 10 in a state where a chuck mechanism is closed. FIG. 4 is a side view showing part of the workpiece holding device 10 in a state where the chuck mechanism is open. As shown in FIG. 2 to FIG. 4, the workpiece holding device 10 includes a jig 11 and a suction chuck unit 20.

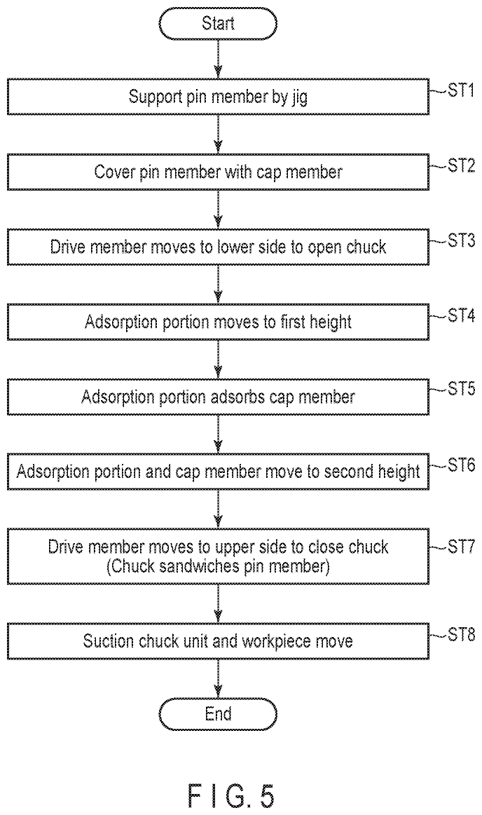

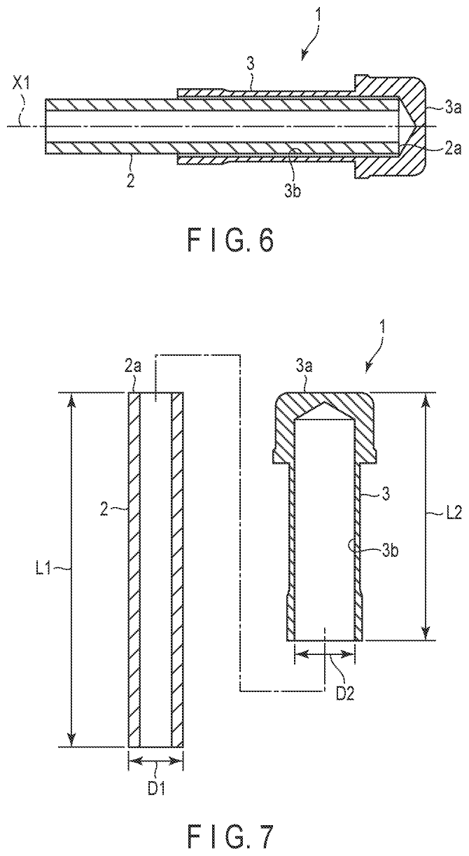

FIG. 5 is a flowchart showing a process for holding a complex workpiece 1 (see FIG. 6). The complex workpiece 1 is held by the suction chuck unit 20 in, for example, manufacturing facilities for assembling devices, etc. The complex workpiece 1 held by the suction chuck unit 20 moves between a plurality of work stages. The flowchart of FIG. 5 is explained in detail later.

Firstly, the complex workpiece 1 is explained with reference to FIG. 6 and FIG. 7. FIG. 6 is a cross-sectional view showing an example of the complex workpiece 1. FIG. 7 is a cross-sectional view in which the complex workpiece 1 is disassembled. The complex workpiece 1 comprises a pin member 2 and a cap member 3. For example, the pin member 2 is a member having the shape of a hollow rod. As another example, the pin member 2 may be a cylindrical coil spring. Each of the pin member 2 and the cap member 3 comprises axis X1 (see FIG. 6) parallel to the length direction. The section of the pin member 2 in a direction perpendicular to axis X1 is circular. The distal end 3a of the cap member 3 is closed.

Length L1 of the pin member 2 (see FIG. 7) is greater than length L2 of the cap member 3. Inside diameter D2 of the cap member 3 is slightly greater than outside diameter D1 of the pin member 2. The pin member 2 can be covered with the cap member 3 from an end 2a of the pin member 2. The end 2a of the pin member 2 is inserted into the hole 3b of the cap member 3. The cap member 3 can move in a direction parallel to axis X1 relative to the pin member 2 in a state where the pin member 2 is inserted into the cap member 3.

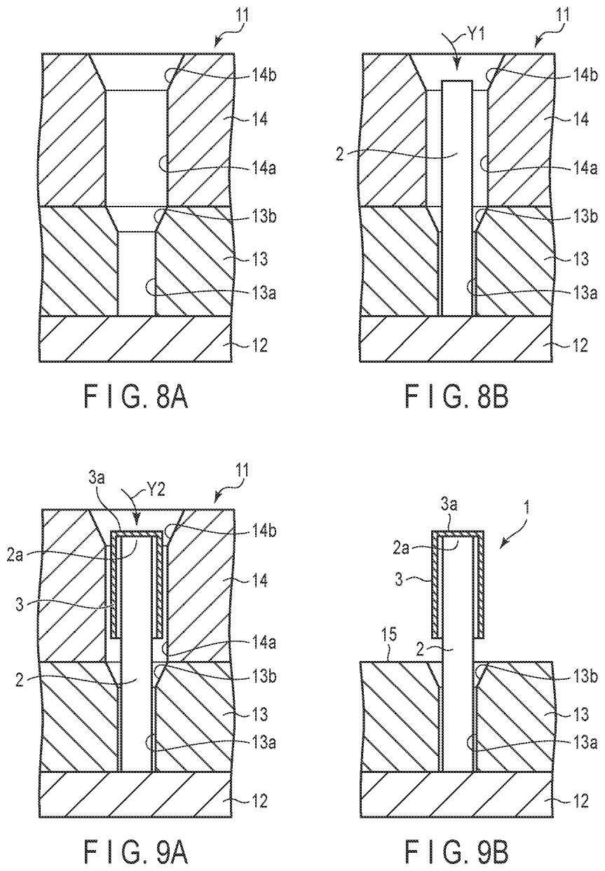

FIG. 8A shows an example of the jig 11. The jig 11 comprises a bottom plate 12, a lower jig 13 provided on the bottom plate 12, and an upper jig 14. The lower jig 13 comprises a first hole 13a extending in a vertical direction and a first guide hole 13b. The inside diameter of the first hole 13a is slightly greater than outside diameter D1 of the pin member 2. The inside diameter of the first guide hole 13b increases in a tapered manner from the upper end of the first hole 13a to the upper jig 14.

The upper jig 14 comprises a second hole 14a extending in a vertical direction and a second guide hole 14b. The inside diameter of the second hole 14a is greater than the inside diameter of the first hole 13a and is also greater than the outside diameter of the cap member 3. The inside diameter of the second guide hole 14b increases in a tapered manner from the upper end of the second hole 14a to the upper surface of the upper jig 14.

FIG. 8B shows a state in which the pin member 2 is inserted into the jig 11. For example, the pin member 2 which is randomly placed on the jig 11 is dropped into the first hole 13a and the second hole 14a from the upper surface of the jig 11 as shown by arrow Y1. The pin member 2 inserted into the first hole 13a and the second hole 14a is supported at a standing position by the lower jig 13.

FIG. 9A shows a state in which the cap member 3 is inserted into the second hole 14a. For example, the cap member 3 which is randomly placed on the jig 11 is dropped into the second hole 14a from the upper surface of the jig 11 as shown by arrow Y2. In this manner, the pin member 2 is covered with the cap member 3 from the upper side of the pin member 2.

FIG. 9B shows a state in which the upper jig 14 is removed. The complex workpiece 1 consisting of the pin member 2 and the cap member 3 is supported at a standing position by the lower jig 13. The complex workpiece 1 supported by the lower jig 13 in this manner is held by the suction chuck unit 20. The suction chuck unit 20 is explained below.

FIG. 1 is a perspective view in which the suction chuck unit 20 is viewed from the lower side. The suction chuck unit 20 is part of the workpiece holding device 10. As shown in FIG. 2 to FIG. 4, the suction chuck unit 20 is provided above the jig 11.

The suction chuck unit 20 comprises an adsorption member 21, a chuck mechanism 22, a drive mechanism 23, etc. The adsorption member 21 comprises a function for adsorbing the cap member 3. The chuck mechanism 22 comprises a function for sandwiching the pin member 2. The drive mechanism 23 comprises a function for opening and closing the chuck mechanism 22 and a function for moving the adsorption member 21 in a vertical direction.

The adsorption member 21 can move in a vertical direction relative to the jig 11. The adsorption member 21 comprises an adsorption body 21a located on the lower part side, and an extension portion 21b which extends from the adsorption body 21a to the upper side. Thus, the adsorption member 21 has a shape which is long in a vertical direction. The adsorption member 21 is supported by a supporting mechanism 30 (see FIG. 3) so as to be movable in a vertical direction. The adsorption member 21 is urged toward the upper side by the supporting mechanism 30.

An adsorption portion 33 comprising suction holes 31 and 32 is provided at the lower end of the adsorption member 21. The suction holes 31 and 32 are connected to a negative pressure generation source 35 (see FIG. 3) through an air flow hole 34. The air flow hole 34 is formed in the adsorption member 21. By sucking air from the suction holes 31 and 32, for example, two cap members 3 can be adsorbed to the adsorption portion 33.

Positioning pins 40 and 41 are provided on the both sides of the adsorption portion 33. The positioning pins 40 and 41 extend downward toward the jig 11. The positioning pins 40 and 41 are formed at positions corresponding to positioning holes 42 and 43. The positioning holes 42 and 43 are formed in the jig 11. The positioning pins 40 and 41 are inserted into the holes 42 and 43 of the jig 11 from the upper side of the jig 11. By this process, the position of the suction chuck unit 20 is determined relative to the jig 11.

The chuck mechanism 22 includes a first chuck member 51 and a second chuck member 52. The first chuck member 51 and the second chuck member 52 can move such that they open and close each other. The first chuck member 51 comprises a pair of first arm portions 51a and 51b, an upper frame 51c and a lower frame 51d. The upper frame 51c connects the upper portions of the first arm portions 51a and 51b to each other. The lower frame 51d connects the lower portions of the first arm portions 51a and 51b to each other.

The first chuck member 51 rotates around a first axis 55 in the directions shown by two-headed arrow R1 of FIG. 4. The first axis 55 is provided in a first supporting portion 56 formed in the adsorption member 21. The first supporting portion 56 is located above the adsorption portion 33. A first chuck surface 57 for gripping the pin member 2 is formed at the lower end of the first chuck member 51.

The second chuck member 52 comprises a pair of second arm portions 52a and 52b, an upper frame 52c and a lower frame 52d. The upper frame 52c connects the upper portions of the second arm portions 52a and 52b to each other. The lower frame 52d connects the lower portions of the second arm portions 52a and 52b to each other. The second chuck member 52 rotates around a second axis 60 in the directions shown by two-headed arrow R2 of FIG. 4. The second axis 60 is provided in a second supporting portion 61. The second supporting portion 61 is formed in the adsorption member 21. The second supporting portion 61 is provided above the adsorption portion 33. A second chuck surface 62 for gripping the pin member 2 is formed at the lower end of the second chuck member 52.

As shown in FIG. 2, the second arm portions 52a and 52b are provided on the external sides of the first arm portions 51a and 52b. As shown in FIG. 1 to FIG. 3, the first chuck member 51 and the second chuck member 52 close each other. When the chuck members 51 and 52 close, the first chuck surface 57 and the second chuck surface 62 are located between the positioning pins 40 and 41.

The first chuck member 51 and the second chuck member 52 are urged such that they close each other by a spring 63. When the first chuck member 51 and the second chuck member 52 have moved to the closed positions, the pin member 2 is sandwiched between the first chuck surface 57 and the second chuck surface 62.

FIG. 3 shows a state in which the first chuck member 51 and the second chuck member 52 are closed each other. When the chuck members 51 and 52 are closed, a first gap portion G1 is defined between a side surface 21c of the adsorption member 21 and the first chuck member 51. A second gap portion G2 is defined between the other side surface 21d of the adsorption member 21 and the second chuck member 52.

In this manner, the gap portions G1 and G2 are present in a state where the pin member 2 is sandwiched by the chuck mechanism 22. These gap portions G1 and G2 allow the chuck members 51 and 52 to move in the radial direction of the pin member 2 to some extent. In other words, the center position at which the chuck surfaces 57 and 62 are coincident with each other can have flexibility in a state where the chuck members 51 and 52 are closed.

The drive mechanism 23 comprises a drive member 65 and a drive source 66 (see FIG. 3). The drive member 65 is movable in a vertical direction relative to the adsorption member 21. The drive source 66 moves the drive member 65 in a vertical direction. The drive source 66 comprises, for example, an actuator such as a servomotor, and moves the drive member 65 to a predetermined position in a vertical direction.

A first cam portion 71 and a second cam portion 72 are formed in the lower part of the drive member 65. These cam portions 71 and 72 function as chuck drive portions. A pressure portion 73 is formed on the lower surface of the drive member 65. The pressure portion 73 functions as a vertical drive portion. A first cam receiving surface 75 is formed in the first chuck member 51. The first cam receiving surface 75 is formed at a position corresponding to the first cam portion 71 under the first cam portion 71. A first load receiving portion 76 is formed at a position corresponding to the pressure portion 73 on the upper surface side of the first chuck member 51.

A second cam receiving surface 80 is formed in the second chuck member 52. The second cam receiving surface 80 is formed at a position corresponding to the second cam portion 72 under the second cam portion 72. A second load receiving portion 81 is formed at a position corresponding to the pressure portion 73 on the upper surface side of the second chuck member 52.

As shown in FIG. 3, when the drive member 65 is located at a rising position, the first cam portion 71 is spaced apart from the first cam receiving surface 75. In addition, the second cam portion 72 is spaced apart from the second cam receiving surface 80. When the first cam portion 71 is spaced apart from the first cam receiving surface 75, the first chuck member 51 is closed by the spring 63. When the second cam portion 72 is spaced apart from the second cam receiving surface 80, the second chuck member 52 is closed by the spring 63.

When the drive member 65 is moved from a rising position to the decreasing end by the drive source 66, as shown in FIG. 4, the first cam portion 71 is in contact with the first cam receiving surface 75. By this process, the first chuck member 51 moves to an open position. Further, as the second cam portion 72 is in contact with the second cam receiving surface 80, the second chuck member 52 moves to an open position.

The first cam portion 71 and the second cam portion 72 function as chuck drive portions for opening and closing the chuck mechanism 22.

When the drive member 65 has been moved to the decreasing end by the drive source 66, the pressure portion 73 comes into contact with the load receiving portions 76 and 81 in a state where the chuck mechanism 22 is open. Thus, the adsorption member 21 moves to the decreasing end, and the adsorption portion 33 is located at the position of a first height H1 (see FIG. 4). Further, the positioning pins 40 and 41 are inserted into the positioning holes 42 and 43. In this manner, the position of the suction chuck unit 20 is determined relative to the jig 11.

When the drive member 65 rises from the decreasing end shown in FIG. 4, the adsorption member 21 moves to the upper position shown in FIG. 3. At this time, the adsorption portion 33 moves to height H2 which is higher than the first height H1 and which is on the rising side relative to the upper surface 15 of the jig 11. As the cam portions 71 and 72 separate from the cam receiving surfaces 75 and 80 in the middle of the move of the adsorption portion 33 to height H2, the chuck mechanism 22 is closed.

Now, this specification explains a method for holding the complex workpiece 1 using the workpiece holding device 10. The adsorption portion 33 of the suction chuck unit 20 of the embodiment comprises a pair of suction holes 31 and 32. Thus, the suction chuck unit 20 can hold two complex workpieces 1 at the same time. However, to simplify explanation, this specification explains a case where one complex workpiece 1 is held by the suction hole 31.

FIG. 5 shows the steps of the process for holding the complex workpiece 1 in order.

In step ST1 shown in FIG. 5, the pin member 2 is inserted into the holes 13a and 14a of the jig 11. An example of the jig 11 is shown in FIG. 8A. As shown in FIG. 8B, the pin member 2 is supported by the lower jig 13 at substantially a perpendicular position.

After the pin member 2 is inserted into the holes 13a and 14a of the jig 11, the cap member 3 is inserted into the hole 14a of the upper jig 14 in step ST2 of FIG. 5. When the cap member 3 is inserted into the hole 14a of the upper jig 14, the pin member 2 is covered with the cap member 3 as shown in FIG. 9A. Subsequently, the upper jig 14 is removed. By this process, as shown in FIG. 9B, the complex workpiece 1 which consists of the pin member 2 and the cap member 3 is supported by the lower jig 13.

After the complex workpiece 1 is supported by the lower jig 13, the suction chuck unit 20 moves to the complex workpiece 1 in step ST3 of FIG. 5. At this time, the drive member 65 moves from the upper position shown in FIG. 3 to the lower position (decreasing end) shown in FIG. 4. In the middle of the move of the drive member 65 to the decreasing end, the cam portions 71 and 72 are in contact with the cam receiving surfaces 75 and 80.

When the drive member 65 further moves to the lower side, the chuck members 51 and 52 move to the open positions as the cam portions 71 and 72 move to the lower side. When the drive member 65 has moved to the vicinity of the decreasing end, the pressure portion 73 comes into contact with the load receiving portions 76 and 81. In this state, the drive member 65 and the adsorption member 21 move to the decreasing end. At this time, the chuck mechanism 22 is open.

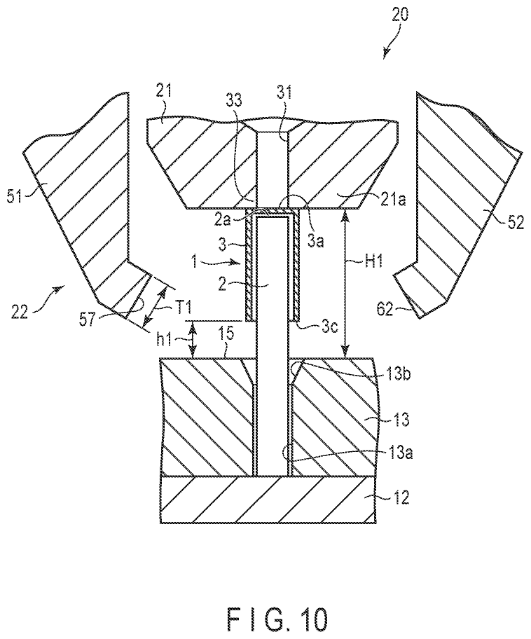

Each of FIG. 4 and FIG. 10 shows a state in which the adsorption member 21 and the drive member 65 have moved to the decreasing end. When the adsorption member 21 reaches the decreasing end in step ST4 of FIG. 5, the adsorption portion 33 is located at the position of the first height H1 relative to the upper surface 15 of the lower jig 13. The adsorption portion 33 faces the upper surface of the cap member 3. The chuck mechanism 22 is in an open state. In step ST5 of FIG. 5, the cap member 3 is adsorbed to the adsorption portion 33 as air is sucked from the suction hole 31.

FIG. 10 shows a state in which the cap member 3 is adsorbed to the adsorption portion 33. The distance from the upper surface 15 of the lower jig 13 to the lower end 3c of the cap member 3 is shown by h1. In some cases, this distance h1 may be less than thickness T1 of each of the chuck surfaces 57 and 62. In this case, when the chuck members 51 and 52 are closed, the cap member 3 is sandwiched between the chuck members 51 and 52. Thus, the pin member 2 cannot be sandwiched.

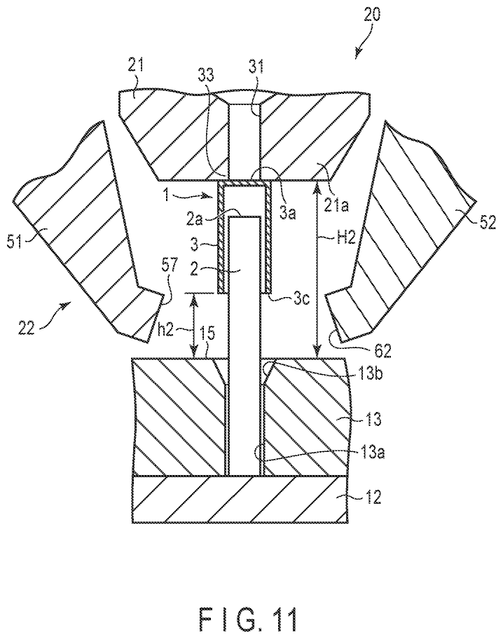

To solve this problem, in step ST6 of FIG. 5, the drive member 65 rises from the decreasing end in a state where the cap member 3 is adsorbed to the adsorption portion 33. As the adsorption member 21 slightly rises as shown in FIG. 11, the adsorption portion 33 is located at the position of the second height H2. In this manner, distance h2 from the upper surface 15 of the lower jig 13 to the lower end 3c of the cap member 3 is made greater than thickness T1 of each of the chuck surfaces 57 and 62.

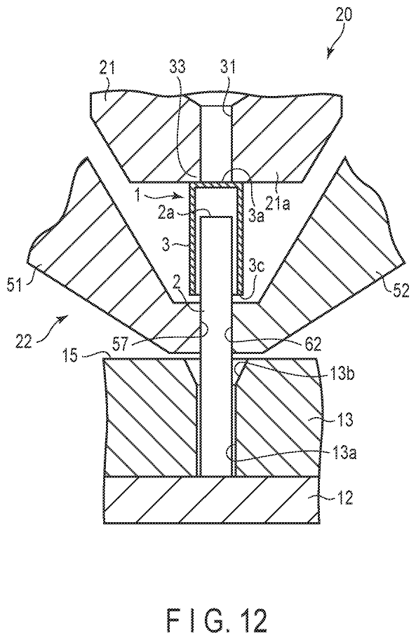

In step ST7 of FIG. 5, when the drive member 65 further rises, the cam portions 71 and 72 separate from the cam receiving surfaces 75 and 80, and the chuck mechanism 22 close. When the chuck mechanism 22 are closed, as shown in FIG. 12, of the pin member 2, the portion which is not covered with the cap member 3 is sandwiched between the chuck members 51 and 52.

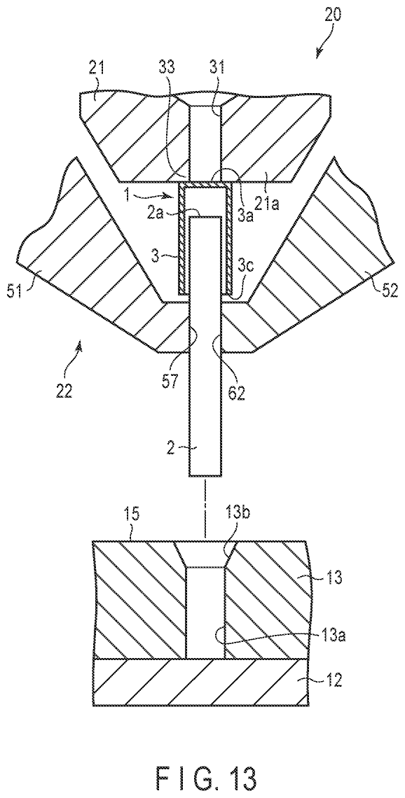

In step ST8 of FIG. 5, as shown in FIG. 13, the suction chuck unit 20 moves to the upper side in a state where the pin member 2 is sandwiched by the chuck mechanism 22. By this process, the complex workpiece 1 is removed from the jig 11. The workpiece 1 removed from the jig 11 is conveyed to a stage which is different from the stage in which the jig 11 is provided.

As described above, the workpiece holding method of the embodiment includes step ST1 to step ST8.

[Step ST1] The pin member 2 is supported at a standing portion by the jig 11.

[Step ST2] The pin member 2 is covered with the cap member 3 from the upper side of the pin member 2.

[Step ST3] The chuck mechanism 22 moves to an open position as the drive member 65 moves to the lower side.

[Step ST4] The drive member 65 further moves to the lower side. When the drive member 65 reaches the decreasing end, the adsorption portion 33 is located at the position of the first height h1. In this manner, the adsorption portion 33 faces the upper surface of the cap member 3.

[Step ST5] The adsorption portion 33 adsorbs the cap member 3.

[Step ST6] As the drive member 65 rises, the cap member 3 rises relative to the pin member 2. By this process, the cap member 3 moves to the second height h2 which is higher than the first height h1.

[Step ST7] As the drive member 65 further rises, the chuck mechanism 22 moves to a closed position. By this process, the pin member 2 is sandwiched by the chuck mechanism 22.

[Step ST8] The suction chuck unit 20 moves to the upper side in a state where the pin member 2 is sandwiched by the chuck mechanism 22. By this process, the complex workpiece 1 is removed from the jig 11.

### [Second Embodiment]

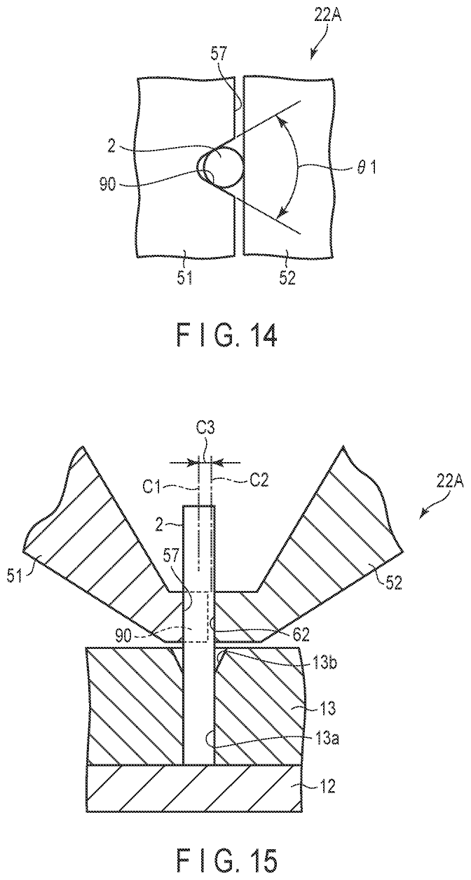

FIG. 14 is a bottom plan view in which part of the chuck mechanism 22A of a workpiece holding device and a pin member 2 are viewed from the lower side according to a second embodiment. FIG. 15 is a cross-sectional view showing part of the chuck mechanism 22A shown in FIG. 14. A trench 90 having a V-shape making angle θ1 is formed on the chuck surface 57 of a first chuck member 51. The other structures are common to the workpiece holding device 10 of the first embodiment and the workpiece holding device of the second embodiment.

In the second embodiment, the chuck mechanism 22A comprises a spring 63 (see FIG. 1, etc.) in a manner similar to that of the chuck mechanism 22 of the first embodiment. The spring 63 urges the chuck members 51 and 52 such that they close. In a state where the chuck members 51 and 52 are closed, a first gap portion G1 (see FIG. 3) is defined between a side surface 1c of an adsorption member 21 and the first chuck member 51. A second gap portion G2 (see FIG. 3) is defined between the other side surface 1d of the adsorption member 21 and a second chuck member 52.

As shown in FIG. 15, in a state where the chuck members 51 and 52 are closed, the pin member 2 is put in the trench 90 of the first chuck member 51. The pin member 2 is sandwiched between the first chuck surface 57 and a second chuck surface 62. Since the pin member 2 is inserted into the hole 13a of a jig 11, the pin member 2 cannot practically move. For this reason, a positional gap C3 is generated between the central axis C1 of the pin member 2 and the center C2 of the chuck mechanism 22. However, this positional gap C3 is allowed as the chuck members 51 and 52 can move in the range of the gap portions G1 and G2.

### [Third Embodiment]

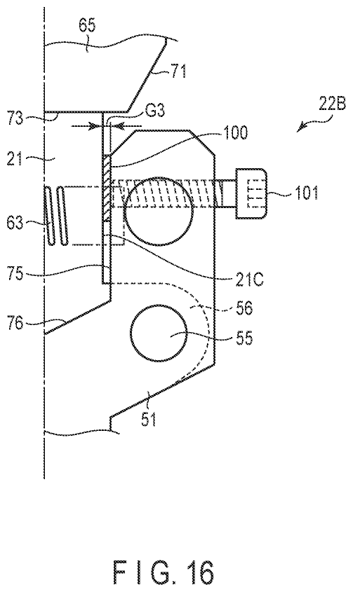

FIG. 16 is a side view showing part of a chuck mechanism 22B according to a third embodiment. A shim member 100 having the shape of a thin plate and having thickness G3 is provided between a side surface 21c of an adsorption member 21 and a first chuck member 51. An adjustment screw 101 for fine adjustment may be used together with the shim member 100. Alternatively, the adjustment screw 101 may be used in place of the shim member 100. The other structures are common to the chuck mechanism 22 of the first embodiment and the chuck mechanism 22B of the third embodiment. Therefore, the common portions are denoted by common reference numbers, an explanation thereof being omitted. The chuck mechanism 22B of the embodiment comprises at least one of the shim member 100 and the adjustment screw 101. Thus, the center position at which chuck surfaces 57 and 62 are coincident with each other can be adjusted in a state where the chuck members 51 and 52 are closed. It should be noted that at least one of the shim member 100 and the adjustment screw 101 may be provided between the other side surface 21d of the adsorption member 21 and the second chuck member 52.

As a matter of course, the present invention can be implemented by modifying the elements constituting the workpiece holding device, such as the chuck mechanism, the adsorption member, the drive member and the drive mechanism. The form of the jig can be also changed depending on the need. In addition, the workpiece holding device of the present invention can be also used for workpieces other than a complex workpiece which consists of a pin member and a cap member. The adsorption member may adsorb the cap member by the magnetic attraction of an electromagnet, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A workpiece holding device which holds a complex workpiece comprising a pin member and a cap member, and comprises:
an adsorption member provided above a jig which supports the complex workpiece, and comprising an adsorption portion which adsorbs the cap member;
a chuck mechanism which comprises a first chuck member and a second chuck member moving so as to open and close each other, and sandwiches, of the pin member, a portion which is not covered with the cap member in a state where the cap member is adsorbed to the adsorption portion; and
a drive mechanism which opens and closes the chuck mechanism.

2. The workpiece holding device of claim 1, wherein
the drive mechanism comprises:
a drive member which is movable in a vertical direction relative to the adsorption member; and
a drive source which moves the drive member in the vertical direction,
the drive member comprises a vertical drive portion and a chuck drive portion,
the vertical drive portion includes a pressure portion,
the pressure portion moves the adsorption portion to a first height facing the cap member, and moves the adsorption portion to a second height which is higher than the first height,
the chuck drive portion includes a cam portion,
the cam portion moves the chuck mechanism to an open position when the adsorption portion moves to the first height, and
the cam portion moves the chuck mechanism from the open position to a closed position when the adsorption portion has moved from the first height to the second height.

3. The workpiece holding device of claim 2, wherein
the drive member comprises the cam portion and the pressure portion.

4. The workpiece holding device of claim 1, further comprising a pair of positioning pins extending downward on both sides of the adsorption portion of a lower surface of the adsorption member.

5. The workpiece holding device of claim 1, further comprising:
a first axis which rotatably supports the first chuck member;
a second axis which rotatably supports the second chuck member;
a spring which urges the first chuck member and the second chuck member such that they close each other;
a first gap portion defined between a side surface of the adsorption member and the first chuck member; and
a second gap portion defined between the other side surface of the adsorption member and the second chuck member, wherein
the first chuck member and the second chuck member are rotatable around the first axis and the second axis, respectively, in a state where the chuck mechanism is closed.

6. The workpiece holding device of claim 1, wherein
a shim member is provided between a side surface of the adsorption member and the first chuck member and/or between the other side surface of the adsorption member and the second chuck member.

7. A workpiece holding method for holding a complex workpiece comprising a pin member and a cap member, the method comprising:
supporting the pin member so as to stand upright by a jig;
covering the pin member with the cap member from an upper side of the pin member;
moving a chuck mechanism to an open position;
moving an adsorption portion for adsorbing the cap member to a first height;
adsorbing the cap member by the adsorption portion;
causing the cap member to rise relative to the pin member by moving the adsorption portion to a second height which is higher than the first height;
sandwiching, of the pin member, a portion which is not covered with the cap member by the chuck mechanism by moving the chuck mechanism to a closed position; and
moving the chuck mechanism to an upper side in a state where the pin member is sandwiched by the chuck mechanism, and removing the complex workpiece from the jig.
